(19) United States
(12) Patent Application Publication
(10) Pub. No.: US 2013/0234625 A1
(43) Pub. Date: Sep. 12, 2013

(54) LIGHTING CONTROL SYSTEM USING MOTION AND SOUND

(71) Applicants: Kazumoto Kondo, San Diego, CA (US); Sho Murakoshi, San Diego, CA (US); Peter Shintani, San Diego, CA (US)

(72) Inventors: Kazumoto Kondo, San Diego, CA (US); Sho Murakoshi, San Diego, CA (US); Peter Shintani, San Diego, CA (US)

(73) Assignee: Sony Corporation

(21) Appl. No.: 13/412,880

(22) Filed: Mar. 6, 2012

(51) Int. Cl. H05B 37/02

(52) U.S. Cl. 315/313

(57) ABSTRACT

A lighting control system uses both motion and sound inputs to control indoor lighting. In the event that a person's motion initially causes the lighting to be energized, the lighting will not be deenergized even if the person's activity is low motion because certain sounds such as doors closing, typing on a keyboard, etc. prevent the lights off timeout from triggering.

### I. FIELD OF THE INVENTION

The present application relates generally to lighting control systems that use both motion and sound as control inputs.

### II. BACKGROUND OF THE INVENTION

Indoor lighting systems have been provided that conveniently relieve people from having to fumble around for a light switch by automatically energizing room lighting when motion is detected. Such systems also advantageously save electricity because after a person leaves the room, perhaps forgetting to extinguish the lights, after a period of time during which no motion is detected the lights are automatically turned off.

As understood herein, such systems suffer from the drawback that it is occasionally the case that a person is working in a room and requires that the lights remain on even if the person's movements are relatively minor. Nevertheless, the lights may automatically be deenergized if insufficient motion is sensed to keep them on, a nuisance requiring arm waving and the like on the part of the exasperated person in the room.

### SUMMARY OF THE INVENTION

An assembly includes a processor receiving signals from a motion sensor and a microphone. A light has an off state and an on state, and a computer readable storage medium bears instructions executable by the processor to determine, based on signals from the motion sensor, whether motion has occurred nearby the motion sensor. Responsive to a determination that motion has occurred nearby the motion sensor, the processor configures the light to assume the on state and commences a timer operation. Then the processor monitors signals from the microphone and responsive to a determination that the signals from the microphone match a predetermined signal, resets the timer operation. On the other hand, responsive to a determination that the signals from the microphone do not match a predetermined signal, the processor determines whether the timer operation has expired, and responsive to a determination that the timer operation has expired, the processor configures the light to assume the off state.

In some implementations, the predetermined signal is characteristic of a sound emitted by a door closing, and/or is characteristic of a sound emitted by a chair squeaking, and/or is characteristic of a sound emitted by a coffee machine percolating, and/or is characteristic of a sound emitted by a person typing on a keyboard.

In another aspect, an assembly includes a processor receiving signals from a vibration sensor. A light has an off state and an on state, and a computer readable storage medium bears instructions executable by the processor to separate the signals from the vibration sensor into at least two spatial dimension components. Responsive to a determination that at least one of the spatial dimension components meets a predetermined criteria, the processor configures the light to have a predetermined one of the on state or off state.

In example embodiments, the vibration sensor includes a piezoelectric-based gyroscope that can sense vibrations in all three spatial dimensions. If desired, the predetermined one of the on state or off state is configured responsive to a determination that at least two spatial dimension components of the signals from the vibration sensor match respective test signals.

In non-limiting implementations the processor further receives signals from a motion sensor, and responsive to a determination that motion has been sensed according to the signals from the motion sensor, the processor configures the light to be in the on state. In these implementations, if desired the instructions may cause the processor to determine whether a door has opened and then closed within a predetermined period based on signals from the vibration sensor, and responsive to a determination that the door has opened and then closed within a predetermined period, maintain the light in the on state even responsive to a determination that a no-motion timer has expired. However, responsive to a determination that the door has not opened and then closed within a predetermined period, the processor may maintain the light in the on state only until a no-motion timer has expired, and then the processor configures the light to assume the off state.

Still further, if desired in some examples the instructions can cause the processor to, subsequent to a determination that the door has opened and then closed within a predetermined period, based on signals from the vibration sensor determine whether a second door open/door shut vibration sequence has been sensed. The processor also determines, based on signals from the motion sensor, whether motion is sensed subsequent to the determination that a second door open/door shut vibration sequence has been sensed. Responsive to a determination that a second door open/door shut vibration sequence has been sensed and that motion is not sensed subsequent to the second door open/door shut vibration sequence, the processor immediately reconfigures the light to the off state.

In other embodiments, the instructions may cause the processor to, based on signals from the vibration sensor, determine if a person is walking shod or unshod. Responsive to a determination that a person is unshod, the processor maintains the light in the on state for at least a first period, whereas responsive to a determination that a person is shod, the processor maintains the light in the on state for a shorter, second period.

In still other embodiments the light is an exterior light of a building, the processor receives signals from a motion sensor, and the instructions cause the processor to determine whether motion has been sensed adjacent the motion sensor. Responsive to a determination that motion has been sensed adjacent the motion sensor, the processor determines whether, in addition to motion, a predetermined vibrational event has been detected based on signals from the vibration sensor. Responsive to a determination that both motion has been sensed adjacent the motion sensor and that in addition to motion a predetermined vibrational event has been detected, the processor configures the light to assume the on state. In contrast, responsive to a determination that either motion adjacent the motion sensor has not occurred, or that the predetermined vibrational event has not been detected, the processor configures the light to assume the off state.

If desired, in this example the predetermined vibrational event may include a vibration with a large z-axis (vertical dimension) amplitude such that people or larger animals walking near the house will cause the light to turn on but more distant sidewalk joggers or vehicles passing on the street will not trigger the light to be energized.

In another aspect, a method includes using both motion and vibration inputs to control lighting. In the event that a person's motion initially causes the lighting to be energized, the lighting is not deenergized even if the person's activity is too low to meet a motion threshold responsive to a determination that certain vibrations have occurred, such as a vibration characteristic of a door closing or a person typing on a keyboard.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a partially schematic diagram of a non-limiting example system in accordance with present principles;

FIG. 2 is a block diagram of an example software architecture that may be implemented by the system of FIG. 1;

FIG. 3 is a flow chart showing example logic using motion and sound to control lighting;

FIG. 4 is a flow chart showing example logic using motion and vibration to control lighting;

FIG. 5 is a flow chart showing example use case logic for controlling interior lighting using motion and vibration;

FIG. 6 is a flow chart showing example use case logic for controlling exterior lighting using motion and vibration;

FIG. 7 is a schematic diagram showing how vibration sensors on a desk can be used to control lighting;

FIG. 8 is a schematic diagram showing how vibration sensors on a desk can be used to dim and brighten lighting;

FIG. 9 is a schematic diagram showing an alternate embodiment of how vibration sensors on a desk can be used to control lighting;

FIG. 10 is a schematic diagram showing vibration sensors incorporated into a lighting base to control lights on the base; and

FIG. 11 is a schematic diagram showing how vibration sensors on a desk can be used to establish a mouse-like input device.

### DETAILED DESCRIPTION OF THE PREFERRED EMBODIMENT

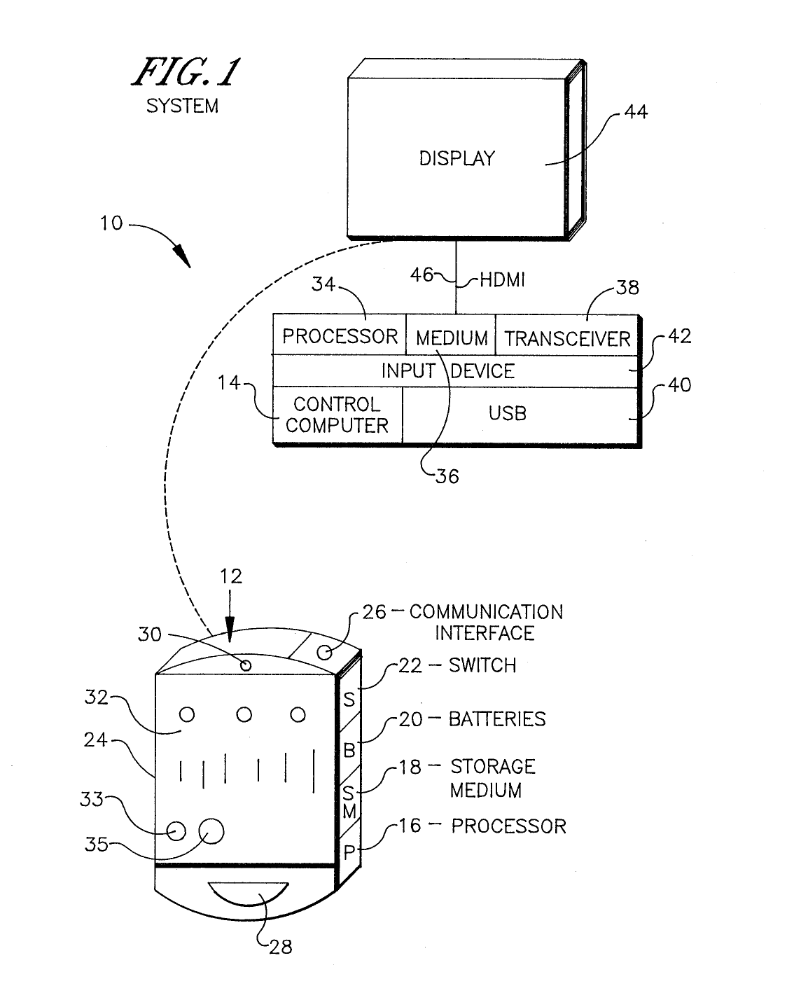

Referring initially to the non-limiting example embodiment shown in FIG. 1, a system 10 includes a wall-mounted lighting controller 12 wirelessly communicating with an intelligent home appliance control computer 14 to execute present principles. While the controller 12 is shown operating in tandem with the control computer 14, it is to be understood that in other embodiments the controller 12, which can include a controller processor 16, may be a standalone device in which the processor 16 executes present logic.

In the example shown, the controller processor 14 may access a computer readable storage medium 18 such as disk-based or solid state storage bearing instructions to cause the controller processor 14 to function according to present principles. The components of the controller 12 may be powered by one or more power sources 20 such as DC batteries, AC power converters, and the like. The controller 12 may also include a switch 22 controlled by the processor 16 to energize and deenergize electrical lighting, typically within a room in which the controller 12 is mounted.

It is to be understood that while the components 16-22 are all shown within a single wall-mountable housing 24, the switch 22, for instance, can be remotely located from the housing 22 and can communicate with the controller processor 16 via a communication interface 26 on the housing 24, with the interface 26 being a wired (e.g., universal serial bus) interface or a wireless (e.g., Bluetooth, ZigBee, Z-Wave) interface (transceiver).

Also supported on the controller housing 24 in the non-limiting example shown is a microphone 28 inputting signals representing sound to the controller processor 16, and a motion detector 30 inputting signals representing motion to the controller processor 16. Note that in some embodiments either or both the motion sensor 30 and microphone 28 may be remotely located from the housing 22 and can communicate with the controller processor 16 via the communication interface 26. However, by placing the switch 22, microphone 28, and motion detector 30 on a common housing 22, all advantageously can be powered by the same power source 20, and the system is made more compact and easier to install than were several pieces to be required to be separately powered and installed in a room. In an example implementation, the motion sensor 30 is an infrared-based motion sensor although other technologies may be used, such as video cameras that analyze for motion in acquired video.

Also, as shown in the example of FIG. 1, the housing 22 may include one or more electrical outlets 32. Power to the electrical outlets 32, into which a lamp cord, for instance, may be plugged, may be routed through the switch 22. Thus, in the integrated form shown in FIG. 1 the controller 12 establishes a single self-contained solution in which all necessary controls are mounted in a single housing that can conveniently replace an existing conventional electrical receptacle. If desired, a manual off-on toggle switch or button 33 may be provided on the housing 24 to enable a person to manually control the position of the switch 22. Also, in addition to or in lieu of the microphone 28, a vibration sensor 35 such as an accelerometer such as a gyroscope that in some embodiments may sense vibrations in the three spatial dimensions may be provided, in the example shown, on the controller housing. Multiple vibration sensors may be provided and they may be mounted on the controller as shown, and/or on walls, floors, tables, etc. according to description below.

Turning to the control computer 14, in the example shown the control computer 14 may include a computer processor 34 accessing one or more computer readable storage media 36 such as disk-based or solid state storage to execute logic herein. The computer processor 34 may communicate with a wireless transceiver 38 and/or wired interface 40 such as a USB port with the controller 12. In an example embodiment, the control computer 14, which may have a more capable processor 34 than the controller processor 16, receives signals representing sound from the controller 12 and analyzes the signals to determine whether the signals match one or more predetermined audio noises, discussed further below. In other embodiments, the signal analysis is executed by the controller processor 16.

Additionally, the control computer 14 may receive user commands from one or more input devices 42 such as keyboards, keypads, mice, voice recognition software, etc. and may output video on a display 44. When the display 44 is a high definition (HD) video display the video may be sent to the display on a high definition multimedia interface (HDMI) link 46.

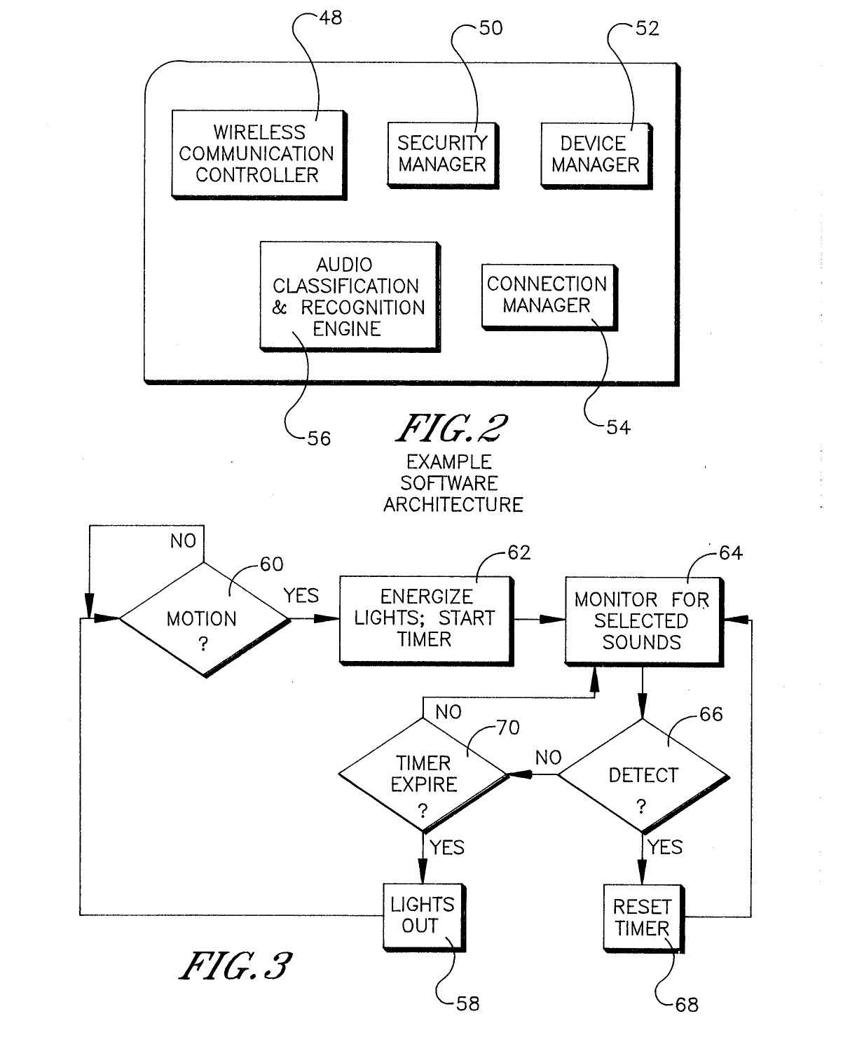

FIG. 2 shows portions of example non-limiting software architecture that may be embodied in one or both of the controller 12/control computer 14. As shown, when wireless communication is used, a wireless communication management module may be executed by the relevant processor to manage the wireless communication. Also, particularly when the control computer 14 is used, a security manager module 50, device manager module 52, and connection manager module 54 may be executed by the relevant processor to respectively manage security (ensuring proper authentication, for example, of connecting devices by examining their log on credentials), connected devices (including, e.g., the controller 12 and display 44), and connections (e.g., to the controller 12 and display 44).

As also contemplated herein, an audio classification and recognition module 56 may be executed by either of the processors 16, 34 shown in FIG. 1 to determine if predetermined noises such as the sound of a door closing, a chair squeaking, a coffee machine percolating, or a person typing on a keyboard have been detected by the microphone 28 according to logic below. In an example embodiment the audio classification and recognition module 56 may function according to principles set forth in U.S. Pat. No. 7,995,440.

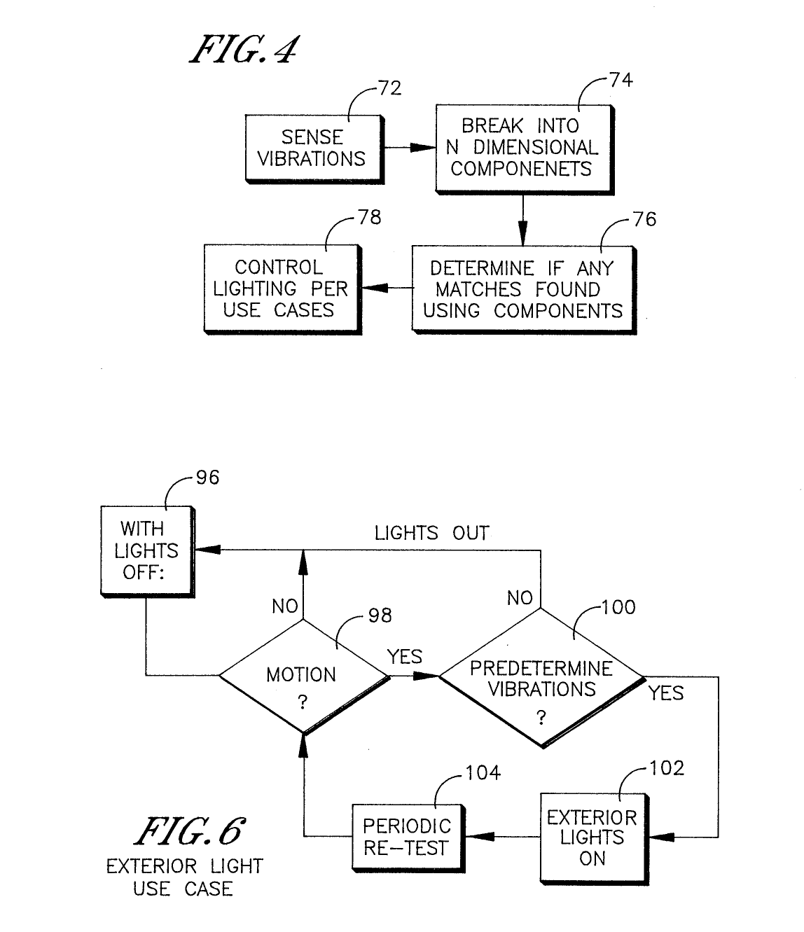

Now referring to FIG. 3 for an illustration of example logic that may be executed by any of the processors herein, commencing at block 58 with the lights out (e.g., with the switch 22 open to open the electrical circuit of the electrical outlet 32), it is determined at decision diamond 60 whether, based on signals from the motion sensor 30, motion has occurred in a room in which the controller 12 is disposed. If so, the logic flows to block 62 to close the switch 22 or otherwise energize lighting in the room. Also, a down-counting timer is started.

At block 64 selected sounds may be monitored for by analyzing the signals from the microphone 28. If a selected sound is detected at decision diamond 66, the timer is reset at block 68 and the logic loops back to block 64 to continue monitoring for selected sounds. Note that detection of more than one selected sound may be required to cause the logic to move from decision diamond 66 to block 68.

On the other hand, if no selected sound is detected at decision diamond 66, the logic may proceed to decision diamond 70 to determine whether the count down timer has expired. If it has not expired the logic loops back to block 64, but if the timer reaches its expiration, the logic moves to block 58 to deenergize the room lighting by, e.g., opening the switch 22.

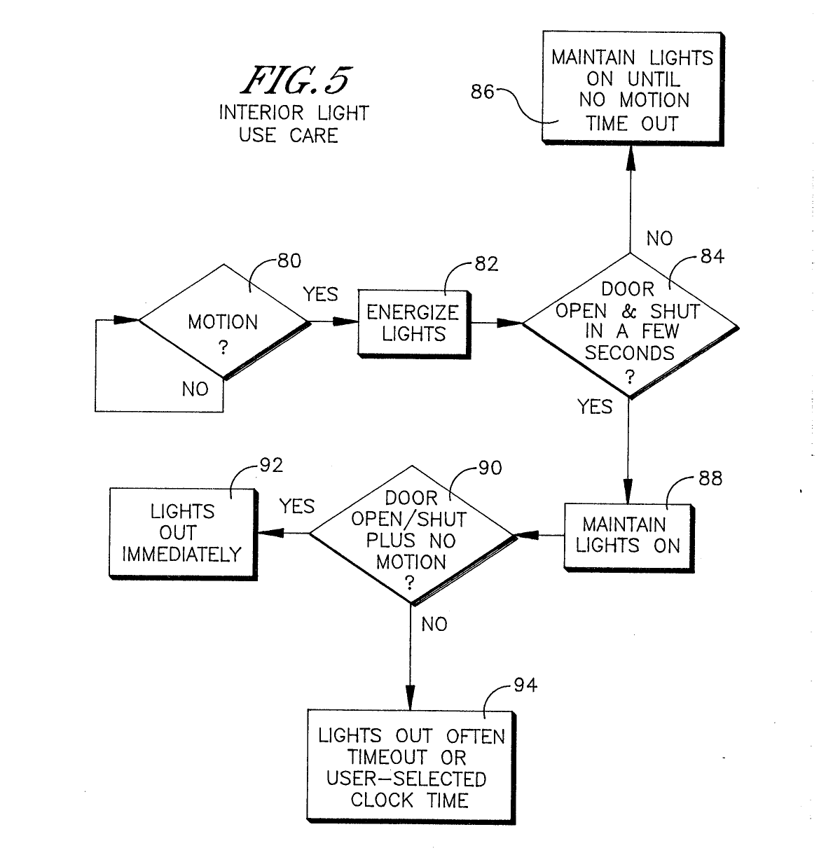

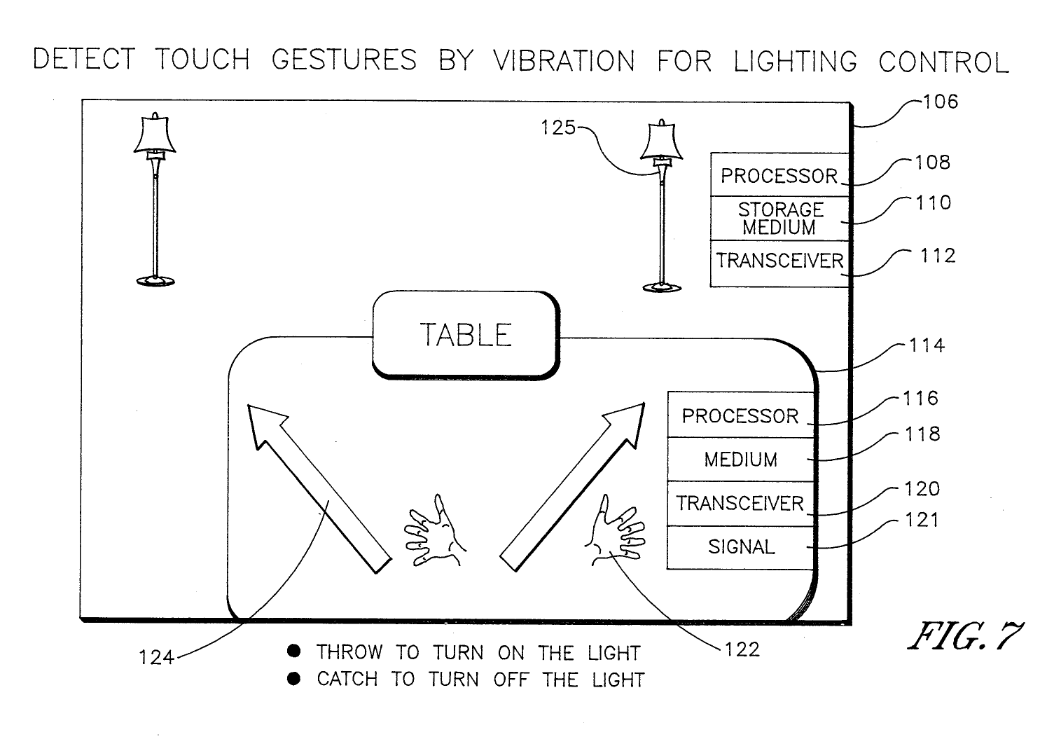

Block 72 of FIG. 4 illustrates an alternate embodiment in which the vibration sensor 35 in FIG. 1 may input signals to the processor for analysis thereof to determine whether to energize or deenergize lighting. When the vibration sensor 35 is, for example, a piezoelectric-based gyroscope that can sense vibrations in all three spatial dimensions such that discrimination of x-axis vibrational components from y-axis vibrational components from z-axis vibrational components is possible, the logic may, at block 74, break down the vibration signal into at least two spatial components. Then, at block 76 it is determined whether any matches are found between the two or more sensed vibrational components and a database of test signals. Lighting is controlled at block 78 according to, as but two examples, the following use cases illustrated in FIGS. 5 and 6. Note that a match of only a single dimensional component with a test signal for that dimension can be determined to be insufficient if the other sensed dimensional components do not match test signals for those dimensions. Or, if two out of three dimensional components match corresponding test signals, it may be determined that a match is found. By “match” is meant that a sensed signal approximates a test signal in amplitude and shape within a predetermined margin of error.

Now referring to FIG. 5 for an example use case of using vibration to control interior lighting, responsive to motion being sensed at decision diamond 80 the logic energizes interior lights at block 82. Then at decision 84 it may be determined whether a door (typically a portal to the room in which the lighting is disposed) has opened and then closed just prior to or during motion being sensed.

To make this determination, the vibration signal is analyzed to determine if a relatively soft hinge vibration from opening the door is sensed, in one embodiment by determining if x- and y-components in the signal from the vibration sensor both exhibit approximately equally shaped and sized characteristics. Then, if a second vibration signal is sensed within a predetermined time prior of the first, e.g., within ten seconds, and the second signal evidences characteristics of a door shutting, e.g., a high amplitude spike in the x-dimension component (orthogonal to the plane of the door), it is inferred that a door open-door shut case has been detected.

When the looked-for vibration pattern is not determined at state 84, the logic may move to block 86 to maintain the lights in the room energized (on) until no motion has been sensed for a timeout period, at which point the lights are deenergized. In contrast, when the looked-for vibration pattern is sensed at state 84, the lights are maintained on at block 88. This recognizes that the presence of motion, at least initially, accompanied by a door opening and closing means that people have entered the room and remain in the room even if their motions are too small for the motion detector to sense and restart the timeout timer.

Subsequently, at decision diamond 90 it is determined whether another door open/door shut vibration sequence has been sensed, coupled with an absence of motion in the room. This suggests that the people have left the room, and responsive to a positive determination the logic immediately extinguishes the lights at block 92 without waiting for the elapse of a no-motion timer. On the other hand, if no door openings/closings have been sensed and no motion has been sensed, the lights may remain on, particularly for applications in which the room is an office space. But for applications in which the room is a bedroom for example and recognizing that people may have entered the room and shut the door, yet would not necessarily desire the lights to remain on indefinitely, in some embodiments a negative test at decision diamond 90 causes the logic to flow to block 94 to extinguish the lights after no motion has occurred for a timeout period or at some user-defined clock time, e.g., midnight.

Additional heuristics for use case can include whether a person has shoes on or is walking in socks. Shod footsteps are characterized by sharper vibration spikes with higher amplitudes than footsteps in bare feet or socks only. If the vibration signal indicates that a person in the room is not wearing shoes, it is more likely that the person will remain indoors, in which case the lights may remain on for a longer period than a default no motion timeout, as an example. Also, individuals have unique characteristics in their gait, speed, or heaviness of footsteps, making it possible to identify an individual within a household by their “footprint”. As an example, heavy slow footsteps in the master bedroom at 2 am could be characteristic of the father going to the bathroom, in which case the lights may be turned on even if it is too dark for the motion sensor to sense motion. On the other hand, if motion is sensed by, e.g., an IR motion sensor but the vibrations indicate fast light footsteps, a household pet may be inferred to be passing through the room and the lights consequently would remain off at night.

FIG. 6 illustrates an example use case for turning exterior lights on. Commencing at block 96 with exterior lights off, it is determined at decision diamond 98 whether motion has been sensed adjacent a garage door or house door. It is to be appreciated in such a case that a controller or at least the motion sensing and vibration sensing components thereof can be mounted on an exterior surface of a building.

If motion has been sensed the logic may move to decision diamond 100 to determine whether, in addition to motion, a predetermined vibrational event has been detected. If both determinations are not positive, the logic maintains the lights out, but when both criteria—motion, and predetermined vibration—have been determined to have occurred, the logic moves to block 102 to turn on the exterior lights. Periodically (e.g., every five minutes) the two tests at diamonds 98 and 100 can be re-run as indicated at block 104.

In example embodiments, the predetermined vibrations tested for at decision diamond 100 may include vibrations with relatively large z-axis (vertical dimension) amplitudes, so that people or larger animals walking near the house will cause the lights to turn on but more distant sidewalk joggers or vehicles passing on the street will not trigger the lights to be energized.

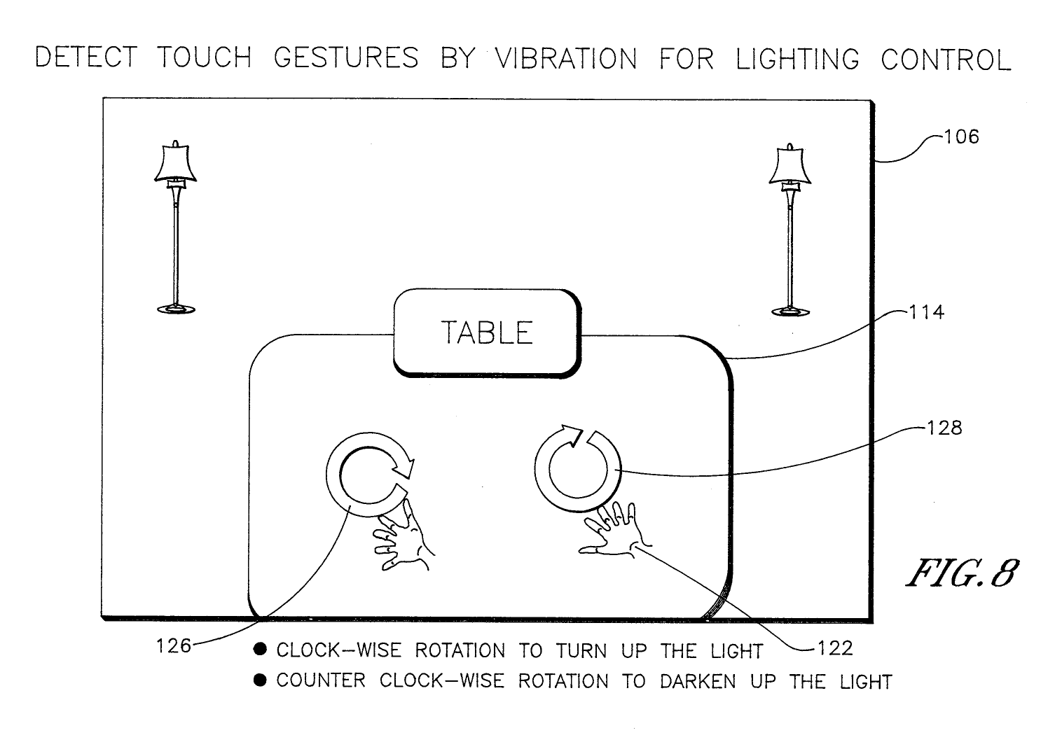

Further inventive aspects may be appreciated in reference to FIGS. 7-13. Assume in FIG. 7 that a room 106 contains a processor 108 accessing a computer readable storage medium 110 and a wired or wireless transceiver 112 for communicating with a desk or table 114 having a processor 116 accessing a computer readable storage medium 118 and a wired or wireless transceiver 120. The table processor 116 receives input from one or more vibration sensors 121 such a gyroscopes or even microphones mounted on the table 114, with the processors 116, 108 in FIG. 7 communicating with each other using their respective transceivers to control lighting in the room. In some embodiments the table processor 118 analyzes vibration signals and simply sends an “on” or “off” signal to the room processor 108, while in other embodiments the sensor 121 signal is sent to the room processor 108 for analysis of the signal by the room processor 108.

Accordingly, as indicated at 122 a human hand moved against the table 114 in a direction 124 toward the room lamps 125 that are controlled by the room processor 108 causes vibrations that are sensed by the vibration sensor 121. When moving toward the lamps as shown, the processor 108, 118 analyzing the vibration signals interprets a “throwing” motion and responsive thereto turns on the lamps 125 if not already on. In contrast, when a user moves his hands against the table in a direction more or less opposite to the arrows 124, a “catching” motion is inferred and the lights are extinguished if on. The vibration signals are analyzed over time to detect the direction of motion, typically using the locus (center or source point) of the vibration as a datum. In an example, the locus of vibration can be determined using triangulation from multiple vibration sensors disposed on the table 114.

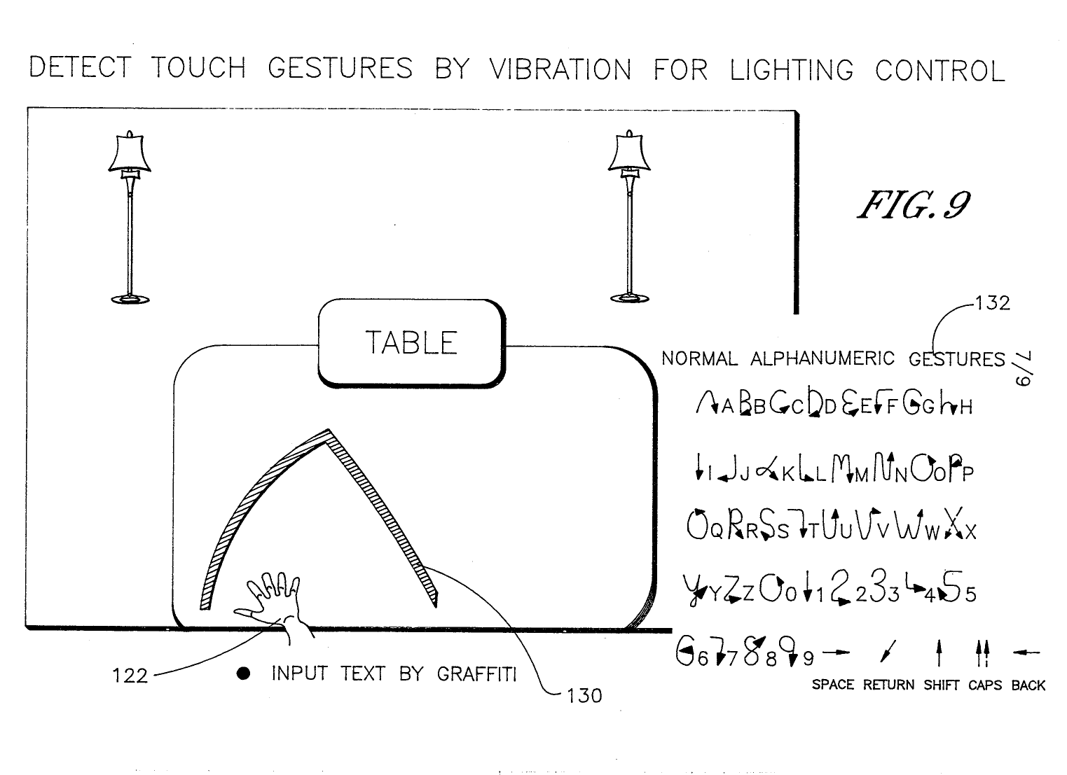

FIG. 8 shows that additionally, the candela output from the lamps can be varied between fully extinguished and full power (to dim the lights and brighten their output) by a hand 122 making a clockwise 126 circle on the table 114 (in one embodiment, to turn the lights brighter) or counterclockwise 128 circle (in one embodiment, to dim the lights without extinguishing them).

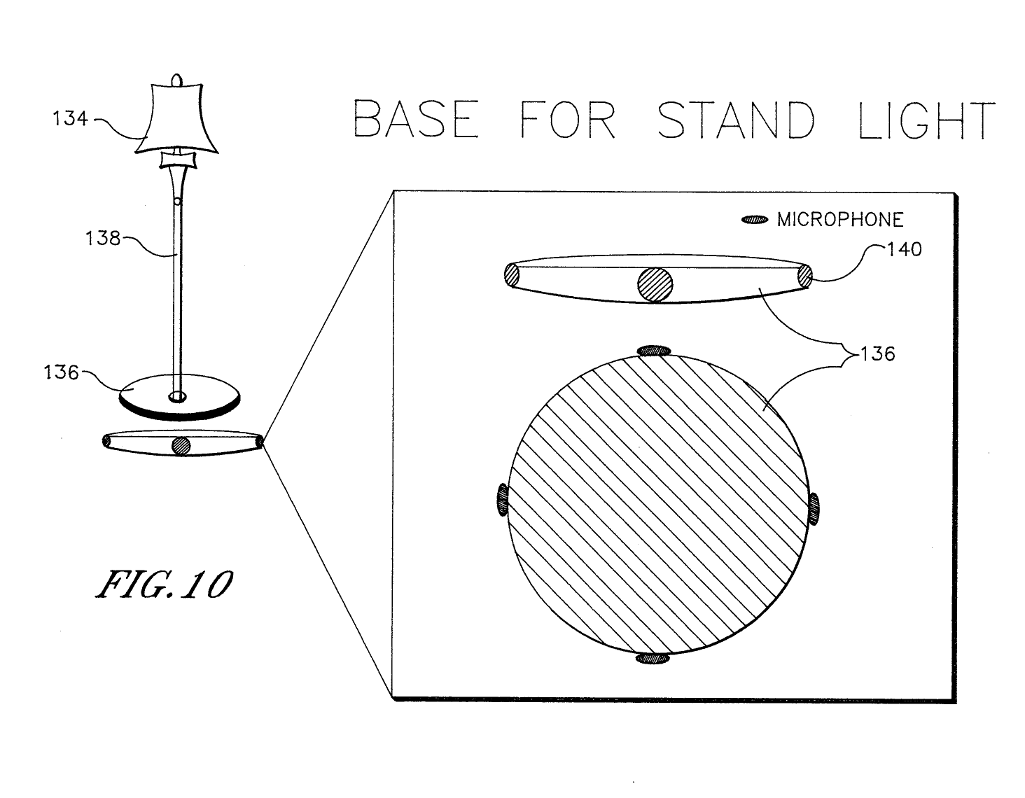

FIG. 9 simply shows that using principles above, vibrations from a hand 122 being moved against the table 114 can be used to enable a person to input text by making a graffiti-like pattern 130 which may be correlated by the processor to an alpha-numeric character or symbol using a pattern correlation table 132 stored in memory. Particular graffiti-like hand motions on the table 114 can establish commands to turn the lights on and off.

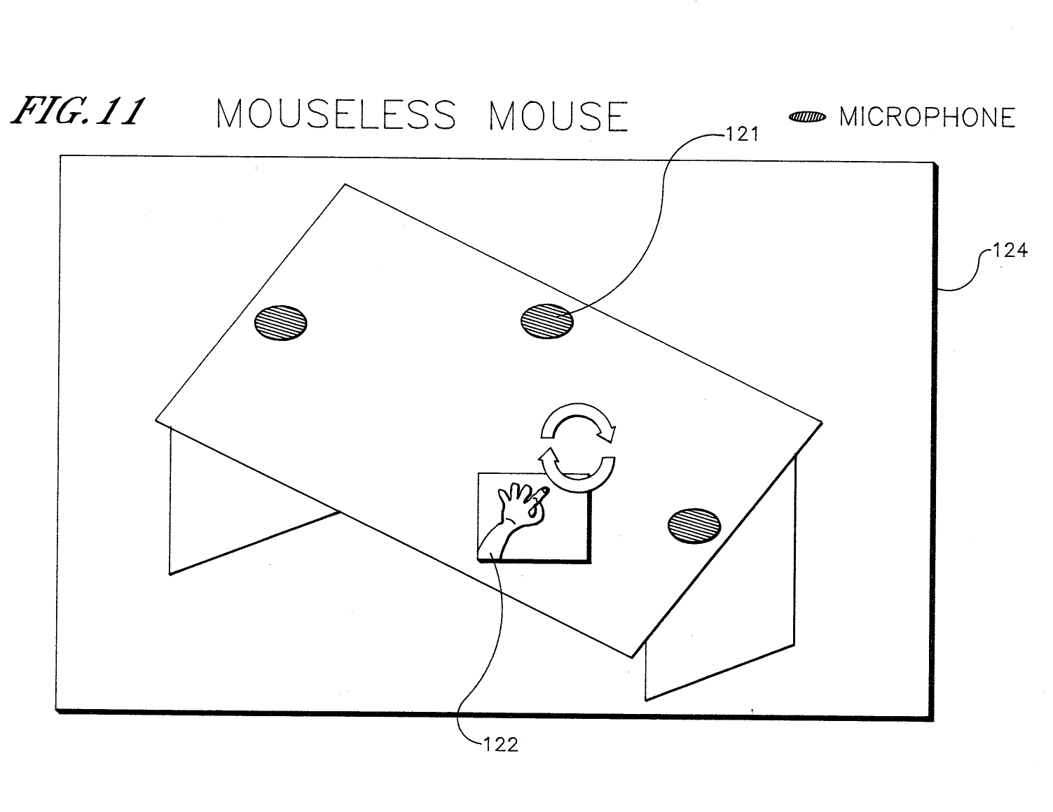

FIG. 10 shows that a lamp 134 may be mounted on a disk-shaped floor base 136 by means of a pole 138, and plural vibration sensors 140 such as microphones may be mounted on the base 136. It is to be understood that the sensors 140 cooperate with processors, transceivers, and switches according to disclosure above to generate signals that can be used to turn the lamp 134 on and off. For example, vibration signals having sufficient magnitude to indicate a person, not a pet, is walking past the lamp can be used to turn the lamp 134 on either accompanied by a motion sensing signal or not. In the embodiment shown, four sensors 140 are symmetrically arranged around the periphery of the base 136.

FIG. 11 shows that motions of the hand 122 against the table 114 can be sensed by vibration sensors 121, in this case, by three vibrations positioned along the left, front, and right edges of the top of the table as shown, to determine the pattern of motion of the hand. This pattern may be input to a processor and used as cursor control input to move a cursor on a computer display such as the display 44 shown in FIG. 1.

In addition to lighting control, the above sensors may be used to start a background music player or radio or TV (e.g., when the above-discussed sound or vibration signals indicate motion), start an alarm system (need to input code) upon sound or vibration sensing, starting a water heater or spa tub upon detection of sound or vibration, energizing a heating blanket upon detection of sound or vibration, starting a gas fire in a fireplace upon detection of sound or vibration, automatically opening motorized window shades upon detection of sound or vibration, starting a fan or air conditioner for cooling (in the summer) upon detection of sound or vibration, reconfigure a component in sleep mode to be in full power (wake up) mode including satellite TV, cable TV, terrestrial TV, and IPTV receivers as well as a TV and PC. Also, the detection of excessive noise or vibration (e.g., above a threshold amplitude) can trigger stopping or deenergizing sources of noise such as a washing machine, clothes dryer, dish washing machine or dryer, garbage disposal, trash compacter, or vacuum system. Likewise, upon the detection of noise or vibration, automatic systems such as a phone answering machine, irrigation system, or security lighting may be deenergized since the noise or vibration indicates that a person is present to take over control of such systems.

While the particular LIGHTING CONTROL SYSTEM USING MOTION AND SOUND is herein shown and described in detail, it is to be understood that the subject matter which is encompassed by the present invention is limited only by the claims. For example, present principles may be incorporated into a smart phone such that various behavior as would be reflected by a recognized sound would trigger recording into the phone as a “life log”.

What is claimed is:

1. Assembly comprising:
processor receiving signals from at least one motion sensor and at least one microphone;
at least one light having an off state and an on state; and
computer readable storage medium bearing instructions executable by the processor to:
determine, based on signals from the motion sensor, whether motion has occurred nearby the motion sensor;
responsive to a determination that motion has occurred nearby the motion sensor, configure the light to assume the on state and commencing a timer operation;
monitor signals from the microphone;
responsive to a determination that the signals from the microphone match a predetermined signal, reset the timer operation;
responsive to a determination that the signals from the microphone do not match a predetermined signal, determine whether the timer operation has expired; and
responsive to a determination that the timer operation has expired, configure the light to assume the off state.

2. The assembly of claim 1, wherein the predetermined signal is characteristic of a sound emitted by a door closing.

3. The assembly of claim 1, wherein the predetermined signal is characteristic of a sound emitted by a chair squeaking.

4. The assembly of claim 1, wherein the predetermined signal is characteristic of a sound emitted by a coffee machine percolating.

5. The assembly of claim 1, wherein the predetermined signal is characteristic of a sound emitted by a person typing on a keyboard.

6. Assembly comprising:
processor receiving signals from at least one vibration sensor;
at least one light having an off state and an on state; and
computer readable storage medium bearing instructions executable by the processor to:
separate the signals from the vibration sensor into at least two spatial dimension components; and
responsive to a determination that at least one of the spatial dimension components meets a predetermined criteria, configure the light to have a predetermined one of the on state or off state.

7. The assembly of claim 6, wherein the vibration sensor includes a piezoelectric-based gyroscope that can sense vibrations in all three spatial dimensions.

8. The assembly of claim 6, wherein the predetermined one of the on state or off state is configured responsive to a determination that at least two spatial dimension components of the signals from the vibration sensor match respective test signals.

9. The assembly of claim 6, wherein the processor receives signals from a motion sensor, and responsive to a determination that motion has been sensed according to the signals from the motion sensor, the processor configures the light to be in the on state.

10. The assembly of claim 9, wherein the instructions cause the processor to:
determine whether a door has opened and then closed within a predetermined period based on signals from the vibration sensor;
responsive to a determination that the door has opened and then closed within a predetermined period, maintain the light in the on state even responsive to a determination that a no-motion timer has expired;
responsive to a determination that the door has not opened and then closed within a predetermined period, maintain the light in the on state only until a no-motion timer has expired, and then configuring the light to assume the off state.

11. The assembly of claim 10, wherein the instructions cause the processor to:
subsequently to a determination that the door has opened and then closed within a predetermined period, based on signals from the vibration sensor determine whether a second door open/door shut vibration sequence has been sensed;
determine, based on signals from the motion sensor, whether motion is sensed subsequent to the determination that a second door open/door shut vibration sequence has been sensed; and
responsive to a determination that a second door open/door shut vibration sequence has been sensed and that no motion is sensed subsequent to the second door open/door shut vibration sequence, immediately reconfigure the light to the off state.

12. The assembly of claim 6, wherein the instructions cause the processor to:
based on signals from the vibration sensor, determine if a person is walking shod or unshod;
responsive to a determination that a person is unshod, maintain the light in the on state for at least a first period; and
responsive to a determination that a person is shod, maintain the light in the on state for at least a second period, the first period being longer than the second period.

13. The assembly of claim 6, wherein the light is an exterior light of a building, the processor receives signals from a motion sensor, and the instructions cause the processor to:
determine whether motion has been sensed adjacent the motion sensor;
responsive to a determination that motion has been sensed adjacent the motion sensor, determine whether, in addition to motion, a predetermined vibrational event has been detected based on signals from the vibration sensor;
responsive to a determination that both motion has been sensed adjacent the motion sensor and that in addition to motion a predetermined vibrational event has been detected, configuring the light to assume the on state; and
responsive to a determination that either motion adjacent the motion sensor has not occurred, or that the predetermined vibrational event has not been detected, configuring the light to assume the off state.

14. The assembly of claim 13, wherein the predetermined vibrational event includes a vibration with a large z-axis (vertical dimension) amplitude such that people or larger animals walking near the house will cause the light to turn on but more distant sidewalk joggers or vehicles passing on the street will not trigger the light to be energized.

15. Method comprising:
using both motion and vibration inputs to control lighting;
in the event that a person's motion initially causes the lighting to be energized, not deenergizing the lighting even if the person's activity is too low to meet a motion threshold responsive to a determination that certain vibrations have occurred, at least one vibration being characteristic of a door closing or a person typing on a keyboard.

16. The method of claim 15, comprising:
separating the vibration input into at least two spatial dimension components; and
responsive to a determination that at least one of the spatial dimension components meets a predetermined criteria, energizing the light.

17. The method of claim 15, comprising:
determining whether a door has opened and then closed within a predetermined period based on the vibration input;
responsive to a determination that the door has opened and then closed within a predetermined period, maintaining the light on even responsive to a determination that a no-motion timer has expired;
responsive to a determination that the door has not opened and then closed within a predetermined period, maintaining the light in the on state only until a no-motion timer has expired, and then configuring the light to assume the off state.

18. The method of claim 17, comprising:
subsequently to a determination that the door has opened and then closed within a predetermined period, based on signals from the vibration input determining whether a second door open/door shut vibration sequence has been sensed;
determining, based on the motion input, whether motion is sensed subsequent to the determination that a second door open/door shut vibration sequence has been sensed; and
responsive to a determination that a second door open/door shut vibration sequence has been sensed and that motion is sensed subsequent to the second door open/door shut vibration sequence, immediately extinguishing the light.

19. The method of claim 15, comprising:
based on the vibration input, determining if a person is walking shod or unshod;
responsive to a determination that a person is unshod, maintaining the light on for at least a first period; and
responsive to a determination that a person is shod, maintaining the light on for at least a second period, the first period being longer than the second period.

20. The method of claim 15, wherein the light is an exterior light of a building, and the method comprises:
determining whether motion has been sensed based on the motion input;
responsive to a determination that motion has been sensed, determining whether, in addition to motion, a predetermined vibrational event has been detected based on the vibration input;
responsive to a determination that both motion has been sensed and that in addition to motion a predetermined vibrational event has been detected, energizing the light; and
responsive to a determination that either motion has not occurred, or that the predetermined vibrational event has not been detected, extinguishing the light.
